(19) United States
(12) Patent Application Publication
(10) Pub. No.: US 2003/0150782 A1
(43) Pub. Date: Aug. 14, 2003

(54) Screen for paper pulp

(76) Inventor: Chao-Ho Chen, Taichung Hsien (TW)

Correspondence Address: MERCHANT & GOULD PC, P.O. BOX 2903, MINNEAPOLIS, MN, 55402-0903, US

(21) Appl. No.: 10/077,030

(22) Filed: Feb. 14, 2002

(51) Int. Cl. B07B 1/49

(52) U.S. Cl. 209/411

(57) ABSTRACT

A screen includes a backing grid, a plurality of parallel elongated supporting bars, and a plurality of parallel elongated screen bars. The backing grid has a plurality of parallel longitudinal grid parts and a plurality of parallel transverse grid parts connected to the longitudinal grid parts. Each of the supporting bars has a length corresponding to that of a respective one of the transverse grid parts, an outer surface fixed to the respective one of the transverse grid parts, and an inner surface formed with a plurality of parallel and spaced apart grooves. Each of the screen bars is formed integrally with a longitudinal constricted portion mounted on the supporting bars in the grooves, and a longitudinal head portion on one end of the longitudinal constricted portion. Adjacent ones of the screen bars form a longitudinal slot therebetween.

### BACKGROUND OF THE INVENTION

1. Field of the Invention

The invention relates to a screen for paper pulp, more particularly to a screen that can be assembled with relative ease and that has good structural strength.

2. Description of the Related Art

A conventional screen 100 for paper pulp is shown in FIG. 1 to include a top annular frame 3, a bottom annular frame 4, a plurality of intermediate annular frames 2, and a plurality of screen parts 1 fixed between two adjacent annular frames 2,3,4. Each of the screen parts 1 is cut to form a plurality of parallel inclined slots 101, and has a front end 102 and a rear end 103. Each of the intermediate annular frames 2 has a front end 201 and a rear end 202. The top annular frame 3 has a front end 301 and a rear end 302. The bottom annular frame 4 has a front end 401 and a rear end 402.

Paper pulp can be sieved via the slots 101 of the screen parts 1.

The following are some of the disadvantages of the aforementioned screen 100:

1) During assembly, two adjacent screen parts 1 are welded to the intermediate annular frame 2, the top of the uppermost screen part 1 is welded to the top annular frame 3, the bottom of the lowermost screen part 1 is welded to the bottom annular frame 4, and the top annular frame 3, the screen parts 1, the intermediate annular frames 2, and the bottom annular frame 4 are rolled, and the ends thereof are welded together so as to form the screen 100 into a cylinder body. Therefore, assembly of the conventional screen 100 involves a large number of steps, is slow, and results in a relatively low production yield.

2) Since the slots 101 are formed by cutting the screen parts 1, the slot-forming rate is slow. It is also not economical since wearing of the cutter easily occurs.

### SUMMARY OF THE INVENTION

Therefore, the object of the present invention is to provide a screen that can be assembled with relative ease and that has good structural strength.

The screen according to this invention includes a backing grid, a plurality of parallel elongated supporting bars, and a plurality of parallel elongated screen bars.

The backing grid has a plurality of parallel longitudinal grid parts and a plurality of parallel transverse grid parts connected to the longitudinal grid parts.

Each of the parallel elongated supporting bars has a length corresponding to that of a respective one of the transverse grid parts, an outer surface fixed to the respective one of the transverse grid parts, and an inner surface formed with a plurality of parallel and spaced apart grooves.

Each of the parallel elongated screen bars is formed integrally with a longitudinal constricted portion mounted on the supporting bars in the grooves, and a longitudinal head portion on one end of the longitudinal constricted portion. Adjacent ones of the screen bars form a longitudinal slot therebetween.

### BRIEF DESCRIPTION OF THE DRAWINGS

Other features and advantages of the present invention will become apparent in the following detailed description of the preferred embodiment with reference to the accompanying drawings, of which:

FIG. 1 is a perspective view of a conventional screen;

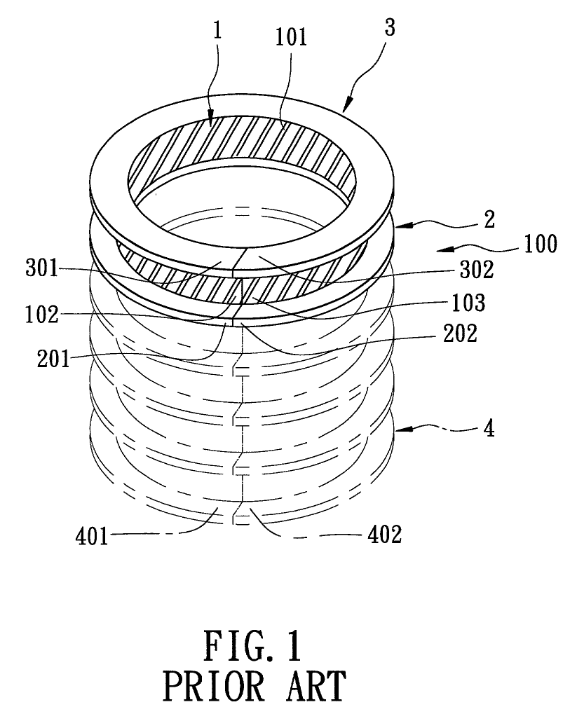

FIG. 2 is a perspective view of the preferred embodiment of the screen according to this invention;

FIG. 3 is an explored perspective view of the preferred embodiment; and

FIG. 4 is a sectional view of the preferred embodiment.

### DETAILED DESCRIPTION OF THE PREFERRED EMBODIMENTS

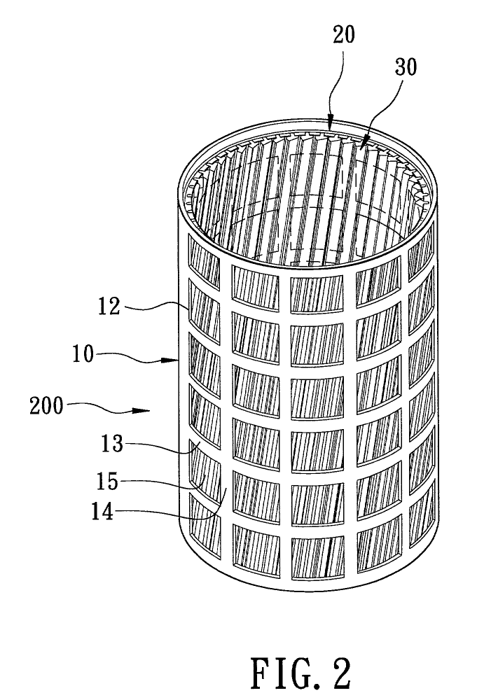

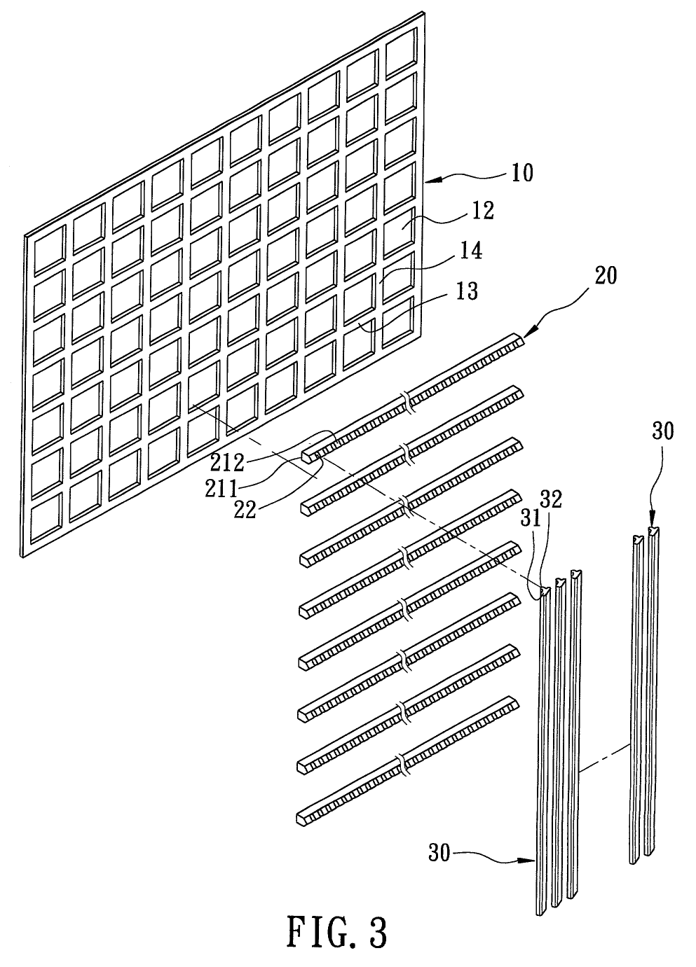

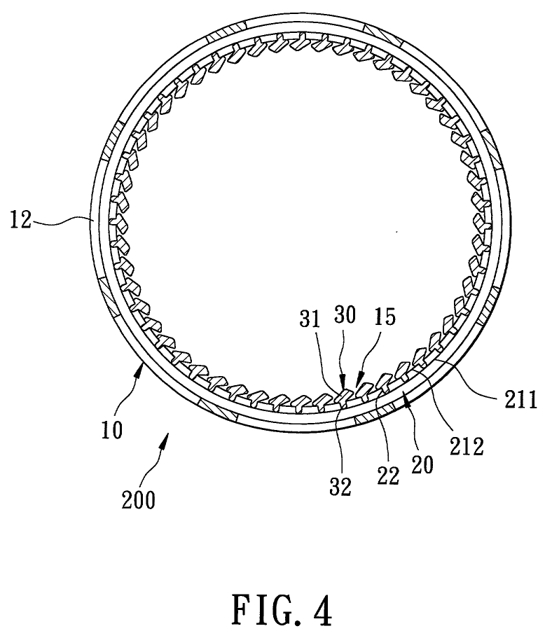

Referring to FIGS. 2, 3 and 4, the preferred embodiment of a screen 200 for paper pulp according to this invention is shown to include a backing grid 10, a plurality of parallel elongated supporting bars 20, and a plurality of parallel elongated screen bars 30.

The backing grid 10 has a plurality of parallel longitudinal grid parts 14 and a plurality of parallel transverse grid parts 13 connected to the longitudinal grid parts 14. The backing grid 10 is formed as a perforated plate via a well-known technique, such as punching.

Each of the parallel elongated supporting bars 20 has a length corresponding to that of a respective one of the transverse grid parts 13, an outer surface 211 fixed to the respective one of the transverse grid parts 13, and an inner surface 212 formed with a plurality of parallel and spaced apart grooves 22.

Each of the parallel elongated screen bars 30 is formed integrally with a longitudinal constricted portion 32 mounted on the supporting bars 20 in the grooves 22, and a longitudinal head portion 31 on one end of the longitudinal constricted portion 32. Adjacent ones of the screen bars 30 form a longitudinal slot 15 therebetween.

During assembly, the backing grid 10 is formed as a perforated plate via a well-known technique, such as punching. An array of holes 12 is defined by the parallel longitudinal grid parts 14 and the parallel transverse grid parts 13. Each of the elongated supporting bars 20 is formed with a plurality of parallel and spaced apart grooves 22 on the inner surface 212 thereof via a cutter. Preferably, the grooves 22 are inclined at an angle relative to the longitudinal grid parts 14. More preferably, the inclined angle is 5°. The outer surface 211 of each of the elongated supporting bars 20 is fixed to the respective one of the transverse grid parts 13. The longitudinal constricted portion 32 of each of the elongated screen bars 30 is inserted into the corresponding grooves 22 of the elongated supporting bars 20 and is fixed thereto by electric discharge welding. Adjacent ones of the screen bars 30 form a longitudinal slot 15 therebetween for sieving paper pulp. Finally, the backing grid 10 together with the supporting bars 20 and the screen bars 30 are rolled, and the two ends thereof are welded together so as to form the screen 200 into a cylinder body.

The dimension of the longitudinal slots 15 can be varied as desired.

In view of the aforesaid, the screen 200 of this invention has the following advantages:

1) The screen 200 according to this invention can be manufactured at a faster processing rate as compared to the aforementioned prior art, and therefore, the production yield thereof can be enhanced.

2) Since the longitudinal slots 15 are formed by fixing the parallel elongated screen bars 30 within the grooves 22 of the supporting bars 20 at equal spacing, the slots 15 with uniform width can be obtained during processing.

3) The structural strength of the screen 200 is further enhanced due to the presence of the backing grid 10.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

I claim:

1. A screen comprising:
a backing grid having a plurality of parallel longitudinal grid parts and a plurality of parallel transverse grid parts connected to said longitudinal grid parts;
a plurality of parallel elongated supporting bars, each of which has a length corresponding to that of a respective one of said transverse grid parts, an outer surface fixed to the respective one of said transverse grid parts, and an inner surface formed with a plurality of parallel and spaced apart grooves; and
a plurality of parallel elongated screen bars, each of which is formed integrally with a longitudinal constricted portion mounted on said supporting bars in said grooves, and a longitudinal head portion on one end of said longitudinal constricted portion, adjacent ones of said screen bars forming a longitudinal slot therebetween.

2. The screen as claimed in claim 1, wherein said grooves are inclined at an angle relative to said longitudinal grid parts.

3. The screen as claimed in claim 2, wherein the angle is 5°.

4. The screen as claimed in claim 1, wherein said backing grid is formed as a perforated plate.

5. The screen as claimed in claim 1, wherein said backing grid, said supporting bars and said screen bars are rolled in order to form a cylinder body having two ends that are welded together.
